(19) United States
(12) Patent Application Publication
(10) Pub. No.: US 2010/0263052 A1
(43) Pub. Date: Oct. 14, 2010

(54) Arbitrary Code Execution System For Preventing Concoction And Analysis Of Computer Execution Codes

(75) Inventors: Suk-Ho Youn, Seoul (KR); Joon-Hwan Seol, Seoul (KR)

Correspondence Address: HYUN JONG PARK;Park & Associates IP Law LLC, 265 Bic Drive, Suite 106, Milford, CT, 06461, US

(73) Assignee: CCR Co., Ltd. (Status: Corporation or Organization, Seoul (KR)

(21) Appl. No.: 12/422,131

(22) Filed: Apr. 10, 2009

(51) Int. Cl. G06F 21/22

(52) U.S. Cl. 726/26

(57) ABSTRACT

Disclosed is an analysis of computer execution codes in that an arbitrary code selected from a plurality of codes of various shapes periodically or frequently during execution of a computer program is stored in a memory of the computer to be executed, so that it can be very difficulty in concocting and analyzing the computer program, whereby securely protecting the computer execution codes. The arbitrary code execution system for preventing the concoction and the analysis of computer execution codes includes: a code pool management module for managing a plurality of codes for storing in a memory of a computer in stead of computer programs; a code control module for selecting and transmitting a specific code among the plurality of codes stored in the code pool management module; and a code execution module for storing the specific code transmitted from the code control module in the memory and executing it as a part of the existing programs.

### FIELD OF THE INVENTION

The present invention relates to an arbitrary code execution system for preventing a concoction and an analysis of computer execution codes. More particularly, the present invention relates to an arbitrary code execution system for preventing a concoction and an analysis of computer execution codes in that an arbitrary code selected from a plurality of codes of various shapes periodically or frequently during execution of a computer program is stored in a memory of the computer to be executed, so that it can be very difficulty in concocting and analyzing the execution code of the computer program, whereby securely protecting the computer execution codes.

### BACKGROUND OF THE INVENTION

Generally, in computer programs, the execution codes are analyzed and manipulated, so that the user information can be snatched from the execution codes or the operation of the execution code can be changed at will. Since such methods are widely and variously well-known, it has a difficulty in protecting them.

FIG. 1 is a conceptional view illustrating an updating status of a conventional computer program in that entire file contents of the program are transmitted or only additional or changed file in terms of a function thereof is transmitted.

As shown in FIG. 1, during the update of the conventional computer program, the entire file contents of the program are transmitted or only additional or changed file in terms of the function thereof is transmitted. That is, where the specific function of the computer program is changed or added, the old program can be changed to a new program through the update thereof. At this time, since the subject of the program itself can be changed, codes of other programs are stored in a memory of the computer. That is, during execution thereof, the code is not changed and the same code can be used and executed every time in the exiting programs.

Accordingly, there are problems in that the execution codes are analyzed and manipulated through a hacker and so on, so that the user information can be leaked or the operation of the execution code can be changed at will, thereby frequently plagiarizing and hacking the private information.

### SUMMARY OF THE INVENTION

Accordingly, the present invention has been made to solve the above-mentioned problems occurring in the prior art, and an object of the present invention is to provide an arbitrary code execution system for preventing a concoction and an analysis of computer execution codes in that a part of execution codes stored already in a memory of a computer can be changed and complemented to other codes every time out of all relations to the change of a function thereof, so that it can completely prevent the concoction and the analysis on the corresponding or related parts thereof.

In order to accomplish the above objects, according to the present invention, there is provided an arbitrary code execution system for preventing a concoction and an analysis of computer execution codes comprising: a code pool management module for managing a plurality of codes for storing in a memory of a computer in stead of computer programs; a code control module for selecting and transmitting a specific code among the plurality of codes stored in the code pool management module; and a code execution module for storing the specific code transmitted from the code control module in the memory and executing it as a part of the existing programs.

In order to accomplish the above objects, according to another embodiment of the present invention, there is provided an arbitrary code execution system for preventing a concoction and an analysis of computer execution codes comprising: a code pool providing server comprising a code pool storing portion for storing a plurality of codes for storing in a memory of a computer in stead of computer programs of a client, a code pool management module for systematically managing the plurality of codes stored in the code pool storing portion so as to transmit them to the desiring client, a code control module for selecting and transmitting a specific code among the plurality of codes stored in the code pool storing portion, and a code pool transmitting portion for transmitting the specific code selected through the code control module to the client; the client comprising a code pool receiving portion for receiving the specific code transmitted through the code pool transmitting portion of the code pool providing server, a code execution module for storing the specific code transmitted from the code pool receiving portion in the memory and executing it as a part of destination programs, the memory for storing the specific code, and a central controller for controlling each element overall; and a communication network for communicating the code pool providing server with the client.

According to the preferred embodiment of the present invention, the plurality of codes is stored in the memory and then, is operated as a part of the destination program.

According to the preferred embodiment of the present invention, an arbitrary code selected from a plurality of codes of various shapes periodically or frequently during execution of the computer program is stored in the memory of the computer to be executed.

### BRIEF DESCRIPTION OF THE DRAWINGS

The above and other objects, features and advantages of the present invention will be more apparent from the following detailed description taken in conjunction with the accompanying drawings, in which:

FIG. 1 is a conceptional view illustrating an updating status of a conventional computer program in that entire file contents of the program are transmitted or only additional or changed file in terms of a function thereof is transmitted;

FIG. 2 is a conceptional view illustrating an arbitrary code execution system for preventing a concoction and an analysis of computer execution codes according to the present invention;

FIG. 3 is a conceptional view illustrating a code pool of an arbitrary code execution system for preventing a concoction and an analysis of computer execution codes according to the present invention;

FIG. 4 is an entire block diagram illustrating an arbitrary code execution system for preventing a concoction and an analysis of computer execution codes according to the present invention;

FIG. 5 is an exampling view illustrating an operation status of an arbitrary code execution system for preventing a concoction and an analysis of computer execution codes according to the present invention;

FIG. 6 is a block diagram illustrating an arbitrary code execution system for preventing a concoction and an analysis of computer execution codes according to another embodiment of the present invention; and

FIG. 7 is an exampling view illustrating an operation status of an arbitrary code execution system for preventing a concoction and an analysis of computer execution codes according to another embodiment of the present invention.

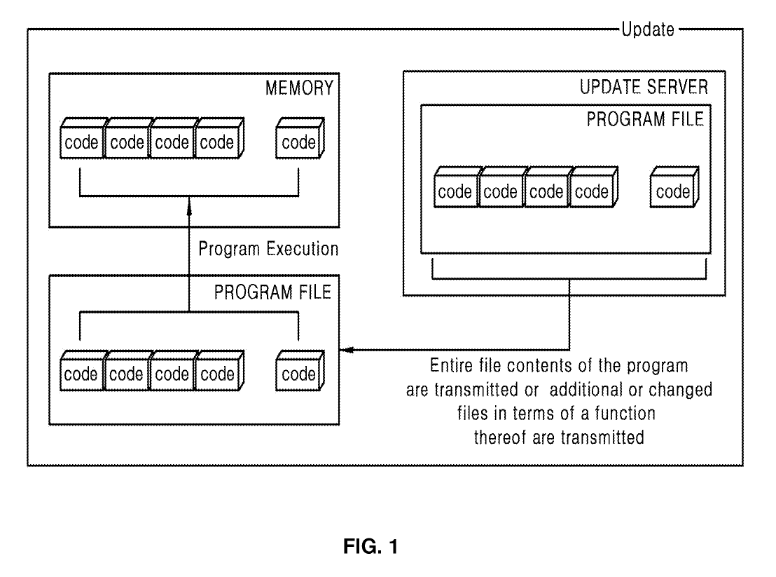

### DETAILED DESCRIPTION OF THE INVENTION

Hereinafter, the present invention will be described with reference to accompanying drawings.

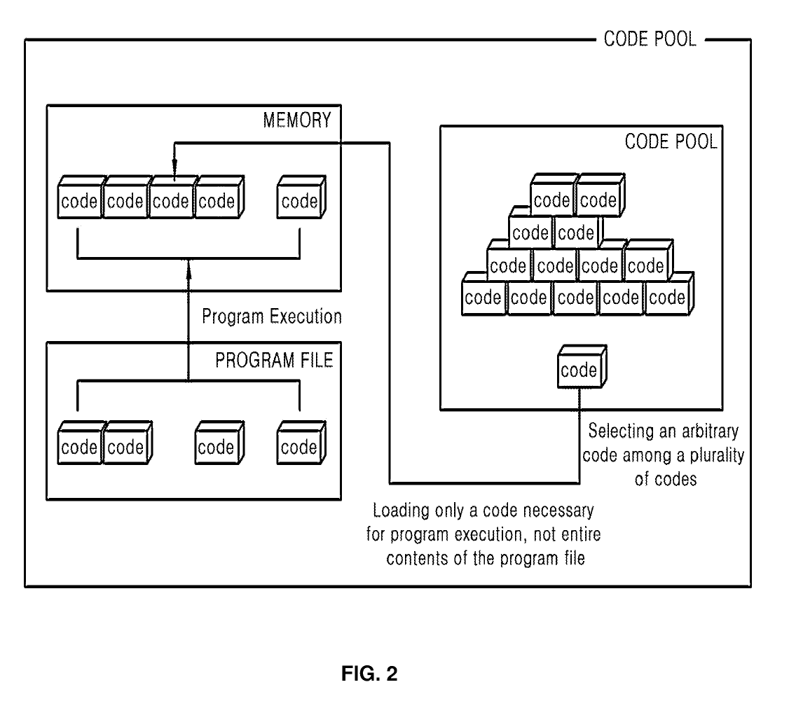

FIG. 2 is a conceptional view illustrating an arbitrary code execution system for preventing a concoction and an analysis of computer execution codes according to the present invention.

As shown in FIG. 2, the arbitrary code execution system for preventing the concoction and the analysis of the computer execution codes according to the present invention serves to select an arbitrary code among a plurality of codes through a code pool management module and load only a code necessary for program execution, not entire contents of the program file.

Accordingly, a part of the execution codes stored already in the memory can be changed and complemented to other codes every time out of all relations to the change of the function thereof, so that it can completely prevent the concoction and the analysis on the corresponding or related parts thereof.

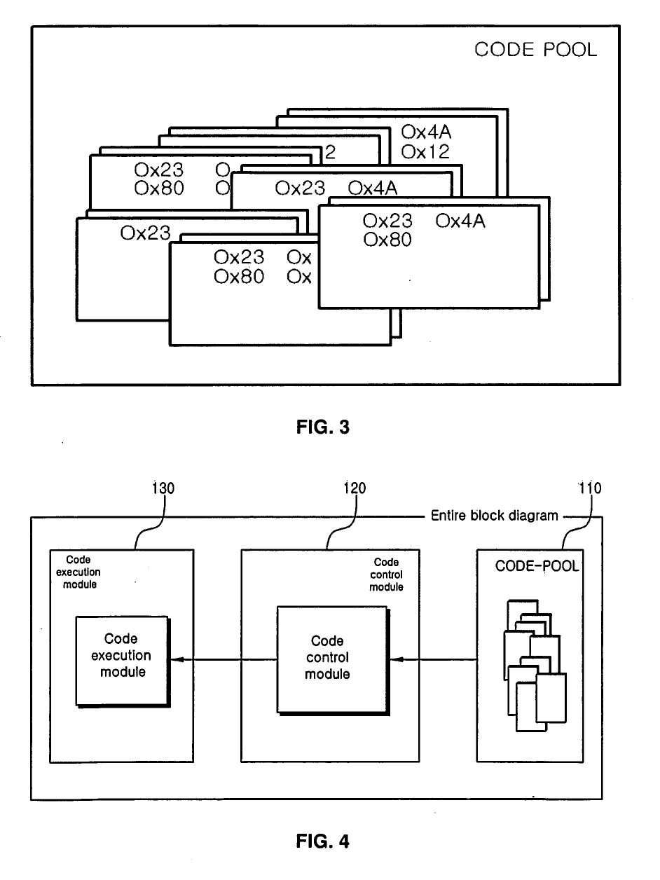

FIG. 3 is a conceptional view illustrating a code pool of an arbitrary code execution system for preventing a concoction and an analysis of computer execution codes according to the present invention.

As shown in FIG. 3, a plurality of codes for storing in the memory in stead of computer programs is collected in the code pool of the arbitrary code execution system for preventing the concoction and the analysis of the computer execution codes according to the present invention.

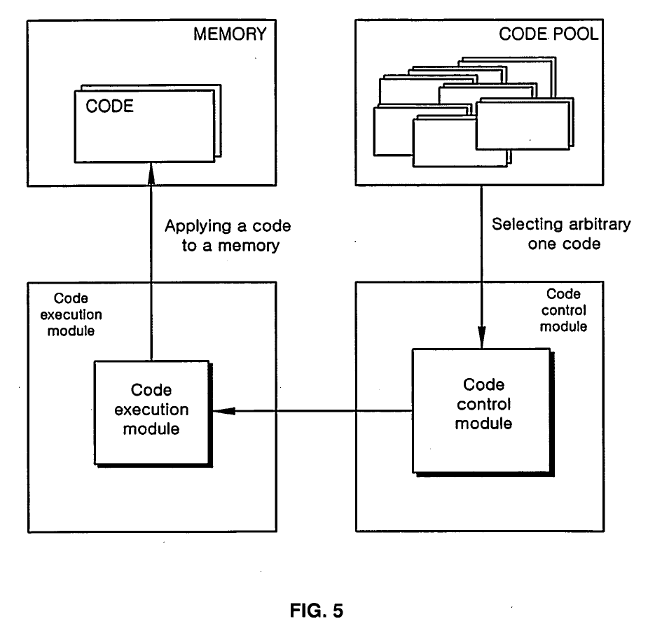

FIG. 4 is an entire block diagram illustrating an arbitrary code execution system for preventing a concoction and an analysis of computer execution codes according to the present invention and FIG. 5 is an exampling view illustrating an operation status of an arbitrary code execution system for preventing a concoction and an analysis of computer execution codes according to the present invention.

As shown in FIG. 4, the arbitrary code execution system for preventing the concoction and the analysis of the computer execution codes according to the present invention includes a code pool management module 110 for managing a plurality of codes for storing in the memory in stead of computer programs in the future, a code control module 120 for selecting and transmitting a specific code among the plurality of codes stored in the code pool management module 110, and a code execution module 130 for storing the specific code transmitted from the code control module 120 in the memory and executing it as a part of the existing programs.

Hereinafter, the operation of the arbitrary code execution system for preventing the concoction and the analysis of the computer execution codes according to the present invention will be described with reference to FIG. 5.

Firstly, the code control module 120 serves to select arbitrary one code from the code pool through the code pool management module 110 for storing and managing the plurality of codes.

Continuously, the code received from the code pool is transmitted to the code execution module 130 through the code control module 120.

Finally, the transmitted code is stored in the memory through the code execution module 130 and then, various works for operating as a part of the destination program are performed.

In this manner, the part of the execution codes stored already in the memory can be changed and complemented to other codes every time out of all relations to the change of the function thereof, so that it can completely prevent the concoction and the analysis on the corresponding or related parts thereof.

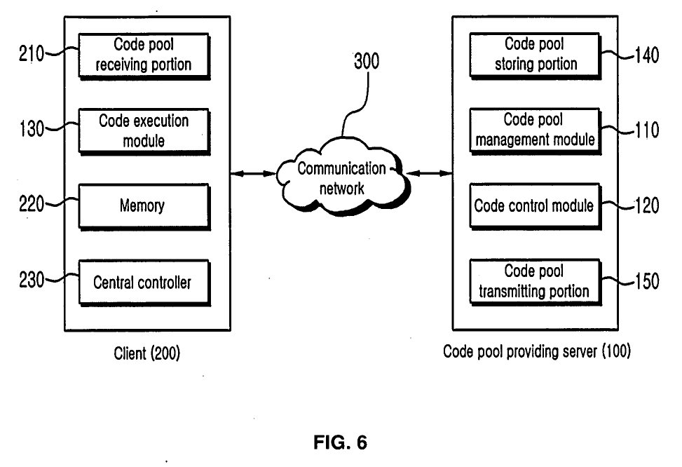

FIG. 6 is a block diagram illustrating an arbitrary code execution system for preventing a concoction and an analysis of computer execution codes according to another embodiment of the present invention.

As shown in FIG. 6, the arbitrary code execution system for preventing the concoction and the analysis of the computer execution codes according to another embodiment of the present invention includes a code pool providing server 100 having a code pool storing portion 140 for storing a plurality of codes for storing in a memory in stead of computer programs of a client 200, a code pool management module 110 for systematically managing the plurality of codes stored in the code pool storing portion 140 so as to transmit them to the desiring client 200, a code control module 120 for selecting and transmitting a specific code among the plurality of codes stored in the code pool storing portion 140, and a code pool transmitting portion 150 for transmitting the specific code selected through the code control module 120 to the client 200; the client 200 having a code pool receiving portion 210 for receiving the specific code transmitted through the code pool transmitting portion 150 of the code pool providing server 100, a code execution module 130 for storing the specific code transmitted from the code pool receiving portion 210 in the memory and executing it as a part of destination programs, the memory 220 for storing the specific code, and a central controller 230 for controlling each element overall; and a communication network 300 for communicating the code pool providing server 100 with the client 200.

Accordingly, the specific code can be transmitted to the client 200 through the code pool providing server 100 on-line or off-line and then, the client 200 can change only the specific code without changing all program or a part of the program, so that it can easily solve the hacking and security problems.

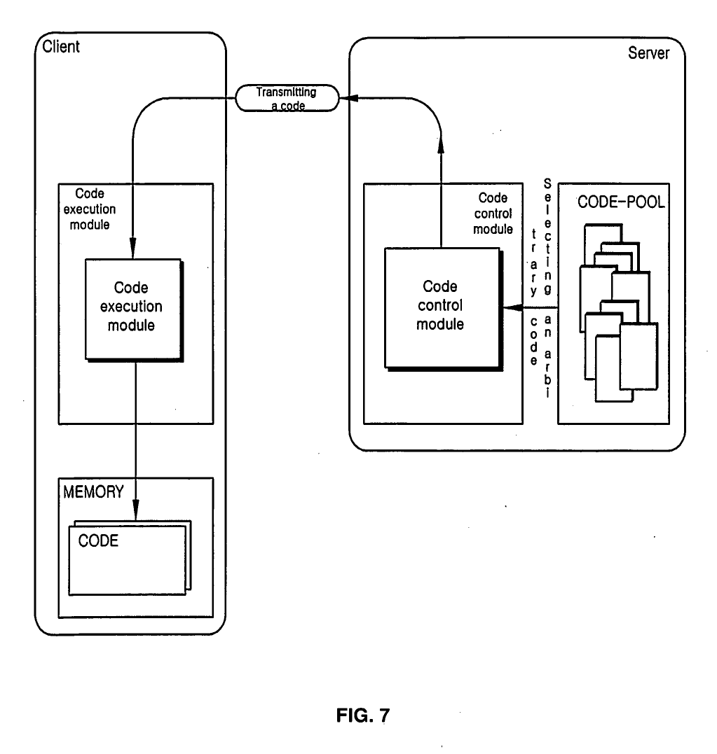

FIG. 7 is an exampling view illustrating an operation status of an arbitrary code execution system for preventing a concoction and an analysis of computer execution codes according to another embodiment of the present invention.

As shown in FIG. 7, firstly, when the client 200 is connected to the code pool providing server 100 through the communication network 300, the code control module 120 serves to select the arbitrary code among the plurality of codes stored in the code pool storing portion 140.

Continuously, the selected code is transmitted to the code pool receiving portion 210 and the code execution module 130 through the code pool transmitting portion 150.

Then, the corresponding code can be changed to a part of the execution program stored in the memory 220.

More concretely, where the client 200 is connected to the code pool providing server 100 through the communication network 300, the code control module 120 serves to select the arbitrary code from the code pool through the code pool management module 110 for storing and managing the plurality of codes.

Continuously, the code received from the code pool providing server 100 is transmitted to the code execution module 130 of the client 200 through the code control module 120.

Finally, the transmitted code is stored in the memory through the code execution module 130 and then, various works for operating as a part of the destination program are performed.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An arbitrary code execution system for preventing a concoction and an analysis of computer execution codes comprising:
a code pool management module for managing a plurality of codes for storing in a memory of a computer in stead of computer programs;
a code control module for selecting and transmitting a specific code among the plurality of codes stored in the code pool management module; and
a code execution module for storing the specific code transmitted from the code control module in the memory and executing it as a part of the existing programs.

2. The arbitrary code execution system as claimed in claim 1, wherein the plurality of codes is stored in the memory and then, is operated as a part of the destination program.

3. The arbitrary code execution system as claimed in claim 1, wherein an arbitrary code selected from a plurality of codes of various shapes periodically or frequently during execution of the computer program is stored in the memory of the computer to be executed.

4. An arbitrary code execution system for preventing a concoction and an analysis of computer execution codes comprising:
a code pool providing server comprising a code pool storing portion for storing a plurality of codes for storing in a memory of a computer in stead of computer programs of a client, a code pool management module for systematically managing the plurality of codes stored in the code pool storing portion so as to transmit them to the desiring client, a code control module for selecting and transmitting a specific code among the plurality of codes stored in the code pool storing portion, and a code pool transmitting portion for transmitting the specific code selected through the code control module to the client;
the client comprising a code pool receiving portion for receiving the specific code transmitted through the code pool transmitting portion of the code pool providing server, a code execution module for storing the specific code transmitted from the code pool receiving portion in the memory and executing it as a part of destination programs, the memory for storing the specific code, and a central controller for controlling each element overall; and
a communication network for communicating the code pool providing server with the client.

5. The arbitrary code execution system as claimed in claim 4, wherein the plurality of codes is stored in the memory and then, is operated as a part of the destination program.

6. The arbitrary code execution system as claimed in claim 4, wherein an arbitrary code selected from a plurality of codes of various shapes periodically or frequently during execution of the computer program is stored in the memory of the computer to be executed.
